(19) United States
(12) Patent Application Publication
(10) Pub. No.: US 2006/0109575 A1
(43) Pub. Date: May 25, 2006

(54) Vehicle mirror assembly

(76) Inventors: Bogdan Radu, Dearborn, MI (US); Alan G. Dry, Grosse Point Woods, MI (US); David A. Hein, Sterling Heights, MI (US)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 10/996,134

(22) Filed: Nov. 22, 2004

(51) Int. Cl. G02B 7/182

(52) U.S. Cl. 359/877; 362/494

(57) ABSTRACT

A mirror flag assembly for a mirror mounted on a vehicle includes a mirror adapted to be mounted on the outside of a vehicle. The mirror has at least one electrical component mounted thereon. A mirror flag housing is adapted to be mounted within the interior of the vehicle. A control for the at least one electrical component is mounted to the mirror flag, the control being electrically connected to the at least one component.

### BACKGROUND OF THE INVENTION

This invention relates in general to vehicular mirror assemblies and, more specifically, to mirror assemblies having a mirror flag with controls for an electrical component of the mirror assembly.

Mirror assemblies are commonly mounted to the door assembly or front pillars of a vehicle. Mirror assemblies may include various electrical components, such as heaters, lights, and motor assemblies. Controls for these various electrical components may be provided within the door panel armrest so that the controls are accessible by a user from within the interior passenger compartment of the vehicle. The controls for the various electrical components of the mirror assembly require space within the door panel and surface area on the door panel armrest. The controls must also be connected to the mirror assembly by wiring disposed within the door panel. Connecting the mirror assembly and controls to one another within the door panel can be difficult and increase the time and cost of manufacturing of the door panel and mirror assembly. Sealing the connection between the mirror assembly outside of the vehicle and the controls within the vehicle can also be cumbersome. Therefore, a control for an electrical component of a mirror assembly that has a compact construction within the vehicle and a quicker installation within the vehicle would be desirable.

### BRIEF SUMMARY OF THE INVENTION

This invention relates to a mirror flag assembly for a mirror mounted on a vehicle. The mirror flag assembly includes a mirror adapted to be mounted on the outside of a vehicle. The mirror having at least one electrical component mounted thereon. A mirror flag housing is adapted to be mounted within the interior of the vehicle. A control for the at least one electrical component is mounted to the mirror flag, the control being electrically connected to the at least one component.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a perspective view of a mirror flag assembly in accordance with the present invention shown installed within a vehicle.

FIG. 2 is a rear perspective view of a portion of the mirror flag assembly shown in FIG. 1 in accordance with the present invention.

FIG. 3 is a partial cross-sectional view of the mirror flag assembly shown in FIG. 1.

FIG. 4 is a perspective view of an alternate embodiment of a mirror flag assembly in accordance with the present invention installed within a vehicle.

### DETAILED DESCRIPTION OF THE PREFERRED EMBODIMENT

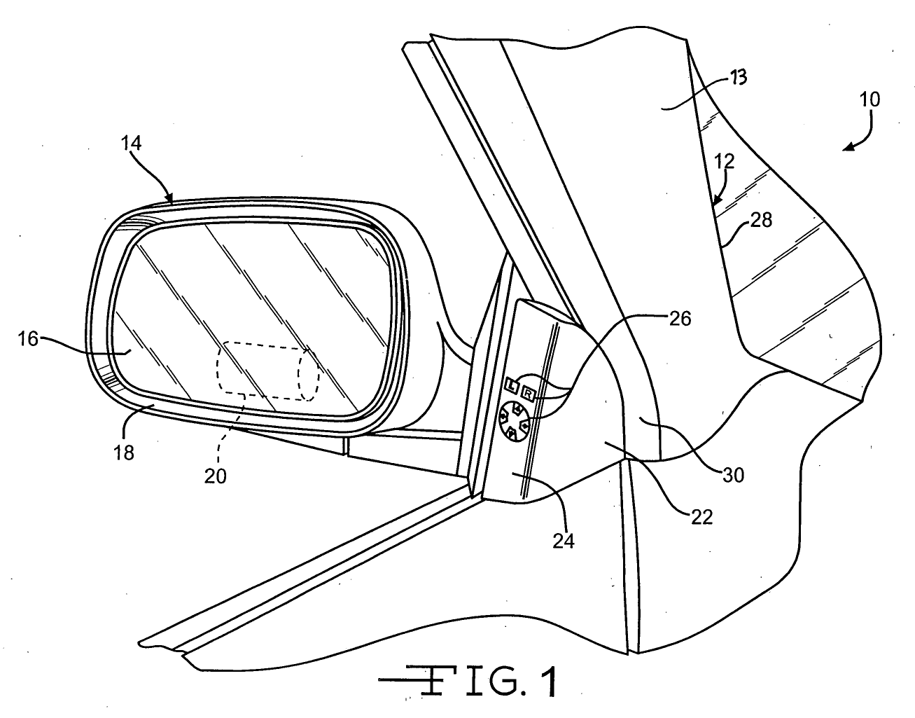

Referring now to the drawings, there is illustrated in FIG. 1 a mirror flag assembly, indicated generally at 10, in accordance with the present invention. The mirror flag assembly 10 is in the form of a side view mirror installed on a vehicle door assembly 12. As shown in FIG. 1, the mirror flag assembly 10 is mounted at the front upper portion of the door assembly 12, such that the mirror flag assembly 10 is positioned behind and below an A-pillar 13 when the door assembly 12 is in the closed position. However, it will be appreciated that the mirror flag assembly 10 may be installed on any portion of a vehicle.

The assembly 10 includes a mirror assembly 14 is mounted on the outside of the vehicle door assembly 12. Another portion of the mirror flag assembly 10 is mounted to the vehicle door assembly 12 so as to be within the interior of the vehicle when the vehicle door assembly 12 is in the closed position relative to the vehicle as will be explained below. The mirror flag assembly 10 is adapted to be mounted on a portion of the interior of the vehicle that is generally adjacent the mirror assembly 14 when the mirror assembly 14 is mounted to the outside of the vehicle.

The mirror assembly 14 includes a reflective mirror 16 disposed within a mirror housing 18. At least one electrical component 20 is mounted within the mirror assembly 14. The at least one electrical component 20 is illustrated schematically in FIG. 1. The at least one electrical component 20 may be any electrical component, such as, for example, a heater, a light, or a motor for adjusting the position of the mirror 16 relative to the housing 18. As illustrated, the at least one electrical component 20 is disposed within the mirror housing 18, although such is not required. It will be appreciated that the at least one electrical component 20 may be included within or on the any portion of the mirror assembly 14.

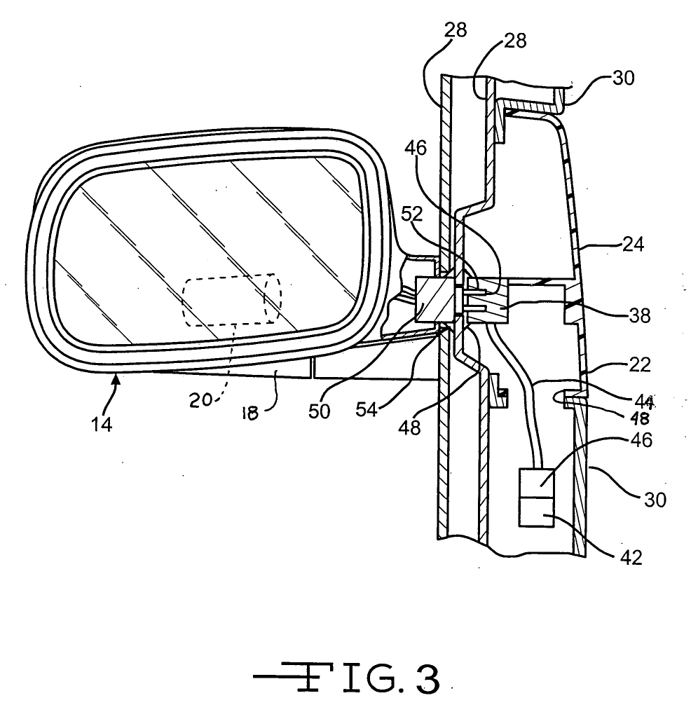

The mirror flag assembly 10 includes a mirror flag housing 22. The mirror flag housing 22 is mounted to the vehicle door assembly 12 so as to extend and be within the interior of the vehicle when the vehicle door assembly 12 is in the closed position relative to the vehicle. The mirror flag housing 22 is adapted to be mounted on a portion of the interior of the vehicle that is generally adjacent the mirror assembly 14 when the mirror assembly 14 is mounted to the outside of the vehicle. Alternatively, the housing 22 may be adapted to mount to extend through an opening of the door assembly 12 and be attached to the mirror assembly 14 thereby mounting the mirror flag assembly 10 to the door assembly 12. In the embodiment shown in FIG. 3, the mirror flag housing 22 includes at least one outer surface 24. At least one control 26 extends from the at least one outer surface 24 for operating the at least one component 20. Each of the at least one control 26 may be electrically connected to a respective one of the at least one component 20. The at least one control 26 is mounted on the mirror flag housing 22 such that the at least one control 26 is accessible by a user from the interior passenger compartment of the vehicle when the vehicle door assembly 12 is in the closed position relative to the vehicle.

Examples of components 20 and controls 26 include an adjustment assembly attached to the mirror 16 for tilting the mirror 16 for a proper viewing angle relative to the driver. The control 26 can be a plurality of switches for tilting the mirror 16 in a generally vertical or horizontal direction. Also, the component 20 can include a heater for heating the mirror 16 for deicing the mirror, wherein the control 26 is an on/off switch. Additionally, the component 20 can be a light for illuminating the ground or for providing a turn signal, wherein the control controls the light.

The at least one control 26 may include a sensor is adapted to generate a signal that is representative of the presence of an object near or in contact with the at least one control 26 and/or the pressure exerted by an object on the at least one control 26. For example, the at least one control 26 may include a non-mechanical or non-movable touch cell or switch, such as, but not limited to, resistive, inductive, piezoelectric and capacitive switches. The at least one control 26 may include a non-contact cell or switch, such as a field effect device, an optical sensor, a magnetic sensor, a Hall Effect device, a Piezo device, and/or a photoelectric device, although such is not required. It will be appreciated that the at least one control 26 may include non-contact cells or switches that require less space within the interior of the vehicle and the mirror flag assembly 22 as compared to other types of conventional switches. In a preferred embodiment, the at least one control 26 may include a field effect cell, such as the Mirus™ detector cells available from the Material Sciences Corporation. In such a preferred embodiment, the cell of at least one control 26 may include a first electrode, a second electrode and an active component (not shown). The second electrode is spaced from and surrounds the second electrode. The active component provides an oscillating electric field to the two electrodes creating an electric field about the cell. When a stimulus interrupts the electric field, the active component of the at least one control 26 senses the interruption and generates a signal indicative of the interruption.

Any portion of the at least one control 26 may be located within the interior passenger compartment of the vehicle so that the sensor portion of at least one control 26 is easily accessible to the driver or passengers within the vehicle. It will be appreciated that the at least one control 26 may include a single sensor device or a plurality of sensors, and each of the plurality of sensors may be capable of generating at least one signal that may be a function of at least one of a plurality of detected conditions. It will also be appreciated that in a preferred embodiment the least one control 26 including any sensors may be insert molded to at least one of the door body 12.

The at least one control 26 may include electroluminescent lighting, although such is not required. The electroluminescent lighting may illuminate the at least one control 26, such that the at least one control 26 is more visible to a user within the passenger compartment of the vehicle. Electroluminescent lighting includes a light emitting phosphor layer sandwiched between two conductive surfaces. Voltage is applied to the conductive surfaces, and an electric field is generated across the phosphor. Electroluminescent lighting operates at a lower temperature than other conventional lighting, so electroluminescent lighting may be able to operate within a mirror flag housing 22 that is smaller and that has less ventilation than conventional lighting may require. Additionally, electroluminescent lighting may have a longer life span than conventional lighting that requires bulbs or other replaceable elements, so access to the at least one control 26 within the mirror flag housing 22 for maintenance of the lighting element is unnecessary or significantly reduced.

The vehicle door assembly 12 may include various structural and trim components. As illustrated in FIG. 3, the vehicle door assembly 12 includes a double walled frame member 28 and a trim component 30 covering the frame member 28, although such is not required. It will be appreciated that the mirror flag housing 22 may be formed integral with any portion of the vehicle door assembly 12 or any other vehicle component to which the mirror flag assembly 10 is mounted thereto.

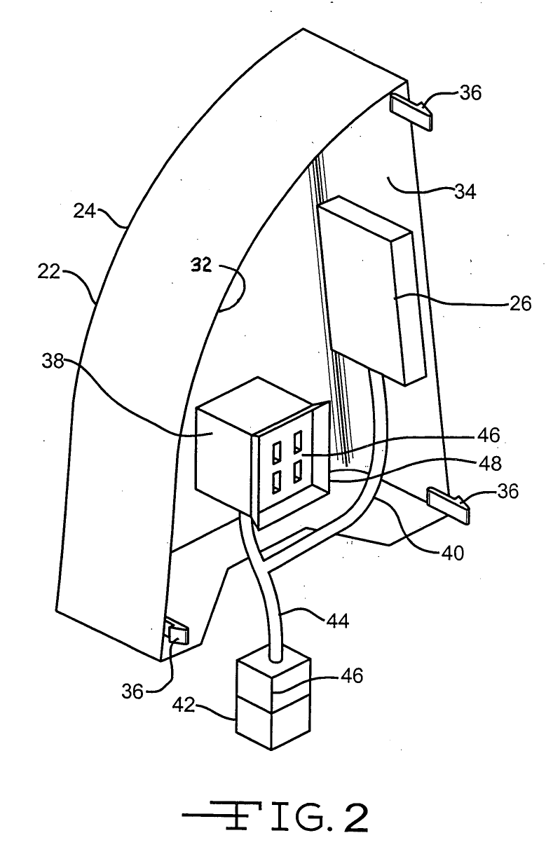

Referring now to FIG. 2, an inner cavity 32 formed by an inner surface 34 of the mirror flag housing 22 is shown. The cavity 32 creates space for the control 26 and the other components, as will be discussed below. The inner surface 34 may include a plurality of tabs 36 for attaching the mirror flag housing 22 to the vehicle door assembly 12, although such is not required. As illustrated, the at least one control 26 extends within the interior cavity 32 of the mirror flag housing 22. Also disposed within the mirror flag housing 22 may be a connector 38 mounted on or formed integral to the inner surface 34. The connector 38 is electrically connected to the at least one control 26 in any conventional manner, such as by at least one wire 40. The connector 38 is also electrically connected to a vehicle system, illustrated schematically at 42, in any conventional manner, such as by at least one wire 44 and a connector 46. As illustrated, the mirror flag housing 22 may include an aperture 48 to allow for the passage of the at least one wire 44 between the connector 38 and the vehicle system 42, although such is not required.

The connector 38 may include an adapter portion 46 that is adapted to communicably connect the mirror assembly 14 to the at least one control 26 and the vehicle system 42. As illustrated, the adapter portion 46 is a female adapter, although it will be appreciated that the adapter portion 46 may be an adapted portion suitable for communicably connecting to the mirror assembly 14, as will be described below. In a preferred embodiment, the connector 38 may be a snap-in connector that snaps into an engaged position relative to the mirror assembly 14. Thus, in the preferred embodiment, the connection of the connector 38 to the mirror assembly 14 requires only the alignment of the connector 38 to the mirror assembly 14 and the required force exerted on the connector 38 to make the snap connection to the mirror assembly 14 as will be described below. A seal 48 may be disposed about the adapted portion 46. As best shown in FIG. 3, the seal 48 seals against the vehicle door assembly 12 to protect the adapter portion 46 of the connector 38 from exterior elements, such as water, dirt, and debris, and to prevent such elements from entering the vehicle door assembly 12 and the interior of the vehicle. The seal 48 may provide a water resistant or water proof seal between the connector 38 and the vehicle door assembly 12, although such is not required.

Referring now to FIG. 3, the mirror assembly 14 further includes a connector 50. The connector 50 includes an adapter portion 52 that is adapted to communicably connect to the adapter portion 46 of the connector 38 and may be sized and configured to correspond to the adapter portion 46. In a preferred embodiment, the connector 38 and the connector 50 may be adapted to connect to one another in a snap-fit fashion, such that the connector 38 and the connector 50 should be aligned with one another and then a required force is applied to one of the connectors 38, 50 to push the connector 38 and connector 50 into contact with one another. The connector 38 and the connector 50 may be shaped correspondingly to create a snap-fit with one another. The connector 38 and the connector 50 may be removably connected to one another, such that the connector 38 and the connector 50 may be separated from one another after snap-fit connection to one another without damage to either of the connectors 38, 50, although such is not required. The connector 38 and the connector 50 may be connected to one another such that removal of the connector 38 from the connector 50 may not be possible without damage to either or both of the connectors 38, 50. A seal 54 may be disposed about the adapted portion 52 to seal against the vehicle door assembly 12 to protect the adapter portion 52 from exterior elements, such as water, dirt, and debris, and to prevent such elements from entering the vehicle door assembly 12 and the interior of the vehicle. The seal 54 may provide a water resistant or water proof seal between the connector 50 and the vehicle door assembly 12, although such is not required. The seal 54 and the seal 48 may cooperate to protect the assembled connector 38 and the connector 50 from exterior elements.

The mirror assembly 14 may be mounted on the vehicle, such that the adapter portion 52 of the connector 50 extends through the frame member 28 of the vehicle door panel assembly 12. The adapted portion 52 may then be used as a primary locator to position the mirror flag assembly 10 relative to the vehicle for mounting. As the mirror flag assembly 10 is positioned for mounting on the vehicle, the adapter portion 46 of the connector 38 will first contact the adapter portion 52 of the connector 50 establishing the alignment of the mirror flag assembly 10 relative to the mirror assembly 14 and the vehicle. It will also be appreciated that the mirror flag assembly 10 could alternately be mounted to the vehicle prior to the mirror assembly 14, such that the adapter portion 46 of the mirror flag assembly 10 becomes the primary locator for positioning the mirror assembly 14 relative to the vehicle. It will further be appreciated that either or both of the adapter portions 46, 52 may float relative to the respective mirror flag assembly 10 and mirror assembly 14, such that either or both of the adapter portions 46, 52 are not used to position the respective mirror flag assembly 10 and mirror assembly 14 relative to the vehicle.

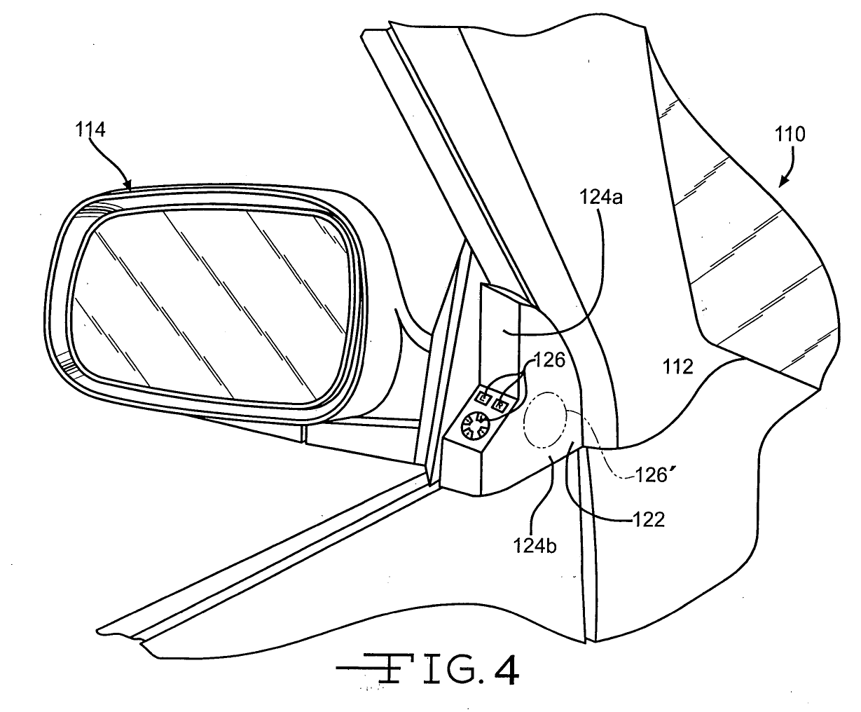

Referring now to FIG. 4, there is illustrated an alternate embodiment of a mirror flag assembly, indicated generally at 110, in accordance with the present invention. The mirror flag assembly 110 is similar to the mirror flag assembly 10 and only the components that differ will be described herein. Many of the components of the mirror flag assembly 110 as illustrated in FIG. 4 are similar in structure and function to corresponding components of the mirror flag assembly 10 as illustrated in FIGS. 1 through 3. Therefore, such corresponding components are indicated by similar reference number in these Figures, but with the components of the mirror flag assembly 110 as illustrated in FIG. 4 having the addition of 100 to each reference number.

The mirror flag assembly 110 is mounted to a vehicle door assembly 112. A mirror assembly 114 is mounted on the outside of the vehicle door assembly 112. The mirror flag assembly 110 is mounted to the vehicle door assembly 112 so as to be within the interior of the vehicle when the vehicle door assembly 112 is in the closed position relative to the vehicle. The mirror flag assembly 110 is adapted to be mounted on a portion of the interior of the vehicle that is generally adjacent the mirror assembly 114 when the mirror assembly 114 is mounted to the outside of the vehicle.

The mirror flag assembly 114 includes a mirror flag housing 122. The mirror flag housing 122 has a first outer surface 124a and a second outer surface 124b. As illustrated, at least one control 126 extends from the first outer surface 124a. However, it will be appreciated that the at least one control 126 may extend from any surface of the mirror flag housing 122, including the second outer surface 124b, as is indicated in phantom at 126′. It will further be appreciated that either of the first outer surface 124a and the second outer surface 124b may be contoured or shaped as desired, such that the at least one control 126 is more easily accessible by a user within the interior of the vehicle.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. A mirror flag assembly for a mirror mounted on a vehicle comprising:
a mirror assembly adapted to be mounted on the outside of a vehicle, the mirror assembly having at least one electrical component mounted thereon;
a mirror flag housing adapted to be mounted within the interior of the vehicle; and
a control for the at least one electrical component mounted to the mirror flag housing, the control being electrically connected to the at least one component.

2. The mirror flag assembly according to claim 1, wherein the mirror flag housing is adapted to be mounted within the interior of the vehicle such that the mirror flag housing is generally adjacent the mirror when the mirror is mounted to the outside of the vehicle.

3. The mirror flag assembly according to claim 1, wherein the control includes a touch cell.

4. The mirror flag assembly according to claim 1, wherein the control includes a non-contact cell.

5. The mirror flag assembly according to claim 1, wherein the at least one electrical component is at least one of a heater, a light, and an adjustment assembly for adjusting the position of a mirror within the mirror assembly relative to the vehicle.

6. The mirror flag assembly according to claim 1, wherein the mirror flag housing further includes an integrally molded connector for electrically connecting the control to the at least one component.

7. The mirror flag assembly according to claim 6, wherein the connector includes a seal for engaging a portion of the vehicle.

8. The mirror flag assembly according to claim 6, wherein the mirror assembly includes a corresponding connector for electrically connecting the connector of the mirror flag housing.

9. The mirror flag assembly according to claim 8, wherein the corresponding connector of the mirror assembly includes a seal for engaging a portion of the vehicle.

10. The mirror flag assembly according to claim 8, wherein the connector of the mirror flag housing engages the connector of the mirror assembly in a snap-fit connection.

11. The mirror flag assembly according to claim 6, wherein the connector of the mirror is the primary locator for aligning the mirror flag relative to the vehicle when the mirror flag is mounted to the vehicle.

12. The mirror flag assembly according to claim 1, wherein the control includes lighting for illuminating the control.

13. The mirror flag assembly according to claim 12, wherein the lighting is electroluminescent lighting.

14. The mirror flag assembly according to claim 1, wherein the mirror flag housing defines a cavity, and wherein a portion of the control is disposed in the cavity.

15. The mirror flag assembly according to claim 1, wherein the control includes one of a field effect device, an optical sensor, a magnetic sensor, a Hall Effect device, a piezo device, and a photoelectric device.

16. A mirror assembly for a vehicle having a mirror mounted on the outside of a vehicle with at least one electrical component mounted thereon comprising:
a mirror flag housing mounted within the interior of the vehicle, the mirror flag housing being adapted to be mounted within the interior of the vehicle such that the mirror flag housing is generally adjacent a mirror when the mirror is mounted to the outside of the vehicle; and
a control for the at least one electrical component mounted to the mirror flag such that the control is accessible from the interior of the vehicle, the control being electrically connected to the at least one component.
